(19) United States
(12) Patent Application Publication
(10) Pub. No.: US 2016/0044467 A1
(43) Pub. Date: Feb. 11, 2016

(54) METHOD FOR IMPROVING THE ACCURACY OF AN INDOOR POSITIONING SYSTEM WITH CROWDSOURCED FINGERPRINTS

(71) Applicant: Cartogram, Inc., Kirkland, WA (US)

(72) Inventor: William Stryker Clausen, Kirkland, WA (US)

(21) Appl. No.: 14/796,049

(22) Filed: Jul. 10, 2015

Related U.S. Application Data
(60) Provisional application No. 62/023,870, filed on Jul. 12, 2014.

(51) Int. Cl. H04W 4/04

(52) U.S. Cl. CPC H04W 4/04

(57) ABSTRACT

A user may manually indicate his or her location using a first IPS-enabled device and share the location with a second device. The first IPS-enabled device may communicate to an IPS backend the user-specified location and information about beacons and their respective signal strengths detected by the first IPS-enabled device at the time that the user indicated his or her location. The IPS backed may forward the location information to a second device, which may or may not be IPS-enabled. The IPS backend may also use the user-specified location and the beacon information received from the first IPS-enabled device to update and maintain a global beacon database to ensure that the global database remains up-to-date for future indoor positioning operations.

### CROSS-REFERENCE TO RELATED APPLICATIONS

This application claims the benefit of, and priority to, U.S. Provisional Application No. 62/023,870 filed on Jul. 12, 2014, which is hereby incorporated by reference in its entirety.

### TECHNICAL FIELD

The present disclosure relates generally to methods, systems, and computer-readable media for improving the accuracy of an indoor positioning system using crowdsourced sensor detection fingerprints.

### BACKGROUND

Recent advances in global positioning system (GPS) technology, have made it possible for the general public to determine their geographic location on a map using small, inexpensive devices such as car navigation systems and smartphones. The ease and reliability of GPS devices are made possible, in part, by the known locations of orbiting satellites that transmit radio signals as part of the universal GPS standard. Although GPS is often reliable for determining geographic location when using GPS devices in outdoor settings, GPS is less reliable in indoor settings, where signal strength may be weakened by structural dielectrics such as roofs, ceilings, and walls. As a result, whereas GPS may enable a device to determine the general geographic location of the building in which it is located, GPS is typically not sufficiently granular or reliable to enable devices to determine their specific location within a building, such as a particular room or hallway.

In light of these and other deficiencies, various indoor positioning system (IPS) technologies have been devised to enable devices to determine their indoor locations in a more granular and reliable manner. For example, some IPSs make use of a system of dispersed indoor beacons to enable devices to approximate their location within an indoor map. As depicted in FIG. 1a, various beacons 110a-110i may be placed within a level 100 of a building, such as a public library. Beacons 110a-110i may be any devices capable of emitting wireless signals, such as electromagnetic radio waves, infrared light signals, or sound waves. In one exemplary embodiment, beacons 110a-110i may emit short-wavelength UHF radio waves in the ISM band using the Bluetooth low energy standard from stationary positions within level 100.

As depicted in FIG. 1b, an IPS-enabled device 200, such as a smartphone carried by a person (not depicted), may be located within level 100. In one exemplary embodiment, device 200 may operate to determine its location within level 100 as follows. Each of beacons 110a-110c may emit information such as its respective MAC address and broadcasting signal strength (also known as Measured Power or Tx Power) at a constant advertising interval, such as every 200 ms, to uniquely identify itself. Device 200 may approximate its distance from each beacon 110a-110c by comparing the received signal strength (RSSI) of each beacon to its Tx Power.

For example, beacon 110a may broadcast at a Tx Power value of −20 dBm. Device 200 may receive the signal broadcast from beacon 110a but, due to distance and other factors, may measure an RSSI of only −35 dBm. Based on the difference between Tx Power and RSSI, device 200 may estimate its distance 120a from beacon 110a using one or more algorithms or estimation techniques known to those skilled in the art. Device 200 may further approximate its distance 120b from beacon 110b and its distance 120c from beacon 110c using the same or similar techniques. Then, assuming that device 200 knows where beacons 110a-110c are located within level 100, device 200 may use trilateration techniques known to those skilled in the art to approximate its position within level 100. Although not depicted, device 200 may also approximate its distance from other beacons 110d-110i and may use such approximated distances as part of its trilateration algorithm to increase the accuracy of its indoor position determination.

As depicted in FIG. 2, in some embodiments, device 200 may be a personal, handheld device, such as a smartphone. Device 200 may include an installed application (or “app”) 210 that performs the above described trilateration using RSSI values provided by hardware or operating system software in device 200. App 210 may access an indoor map 220 associated with level 100 (or its parent building), for example, as already stored in device 200 memory or as retrieved from a backend cloud service that provides nearby indoor maps to IPS-enabled devices in response to GPS coordinates or other information provided by such devices. Device 200 may display indoor map 220 to the user, along with a point 230 that indicates device 200's approximated indoor location within map 220. The user may further select an appropriate level for the indoor map using one or more buttons 240 or other controls that allow the selection of a level.

Although indoor location estimation techniques, such as the trilateration technique described above, can be effective, their effectiveness may be weakened by a dependency on known, static, accurate, and/or comprehensive beacon fingerprint information. As used herein, beacon fingerprint information may refer to information indicating where various beacons are located within a building. In the event that the beacon fingerprint information known to an IPS-enabled device becomes outdated or inaccurate, the accuracy of the IPS-enabled device's approximation of indoor location may suffer.

For example, as depicted in FIG. 3, at a later point in time, beacon 110c could be moved to a different location within level 100. Following such relocation, app 210, or a cloud backend on which app 210 relies, may continue to store beacon fingerprint information indicating the position of beacons 110a-110i that corresponds to the layout depicted in FIG. 1a rather than the updated layout depicted in FIG. 3. As a result, following relocation of beacon 110c, when app 210 evaluates the RSSI values associated with beacons 110a-110c, app 210 may estimate new distance 120c′ that is greater than the previously estimated distance 120c. However, because app 210 may be operating on outdated information that the location of beacon 210 remains unchanged, app 210 may incorrectly estimate its indoor position within level 100 to be new location 330.

Such beacon fingerprint information may become outdated due to any number of factors, such as relocation of beacons, removal of beacons, addition of new or different beacons, degraded or discontinued operation of beacons due to hardware failure or low batteries, or reorganization of internal structures (e.g., walls) or furniture within a building that act as dielectrics to weaken beacon signal strength. And because a building may have hundreds or thousands of individual beacons installed (e.g., to increase the accuracy of indoor location estimation), it may not be practical to manually create or maintain up-to-date beacon fingerprint information on a regular basis.

Accordingly, there is a need for methods, systems, and computer-readable media for automatically updating beacon fingerprint information.

### SUMMARY

The present disclosure addresses these and other needs in the area of indoor positioning systems. In some embodiments, one or more IPS-enabled devices may communicate information about their location, along with information about beacons detected and their respective measured signal strengths at approximately the same time, to an IPS backend. The IPS backend may update a database of beacon information, including assumed locations of beacons, based on the received beacon information. By continually receiving such detected beacon information from IPS-enabled devices, the IPS system may continually, automatically update its beacon database with up-to-date information in lieu of, or as a supplement to, less frequent manual updates to the beacon database.

Additional objects, advantages, and embodiments of the present disclosure will be set forth in part in the description that follows, and in part will be derived from the description, or may be learned by practice of the disclosed embodiments. The objects, advantages, and embodiments of the present disclosure will be realized and attained by means of the elements and combinations particularly pointed out in the appended claims. It is to be understood that both the foregoing general description and the following detailed description are exemplary and explanatory only, and are not restrictive of the present disclosure, as claimed. It is also to be understood that use of the word “exemplary” throughout the application is to be understood as providing examples that may be useful for illustrating general principles or concepts; thus, figures and descriptions identified as “exemplary” should not be interpreted as representing the best or only approaches to practicing the disclosed embodiments.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1a is a diagram depicting an exemplary floor layout in a building in which beacons have been placed in various locations to enable an IPS-enabled device to determine its location within the building.

FIG. 1b is a diagram depicting an exemplary technique for using beacon signal strength to estimate the location of an IPS-enabled device within a building.

FIG. 2 is a diagram depicting an exemplary technique for using an IPS mobile app to display approximated indoor location within a digital map.

FIG. 3 is a diagram depicting an exemplary floor layout in a building in which the location or presence of one or more beacons may have changed as compared with the layout depicted in FIG. 1a.

FIG. 4 is a flowchart illustrating an exemplary method of updating global beacon fingerprint information based on user-specific indoor location information and local beacon fingerprint information.

FIG. 5 is a diagram depicting an exemplary technique for communicating user-specific indoor location information to other users.

FIG. 6 is a diagram depicting an exemplary system configuration for improving the accuracy of an Indoor Positioning System using crowdsourced user-specific location information.

FIG. 7 is a diagram depicting exemplary user-specific indoor location information and local beacon fingerprint information.

FIG. 8 is a diagram depicting an exemplary technique for receiving user-specific location information on a non-IPS-enabled device.

FIG. 9 is a diagram depicting exemplary global beacon fingerprint information as updated over time.

FIG. 10 is a diagram depicting an exemplary hardware configuration that may be used to implement one or more of the disclosed embodiments.

### DETAILED DESCRIPTION

The following detailed description refers to the accompanying drawings. Wherever convenient, the same reference numbers are used in the drawings and the following description to refer to the same or similar parts. While several exemplary embodiments and features of the present disclosure are described herein, modifications, adaptations, and other implementations are possible, without departing from the spirit and scope of the present disclosure. Accordingly, the following detailed description does not limit the present disclosure. Instead, the proper scope of the disclosure is defined by the appended claims.

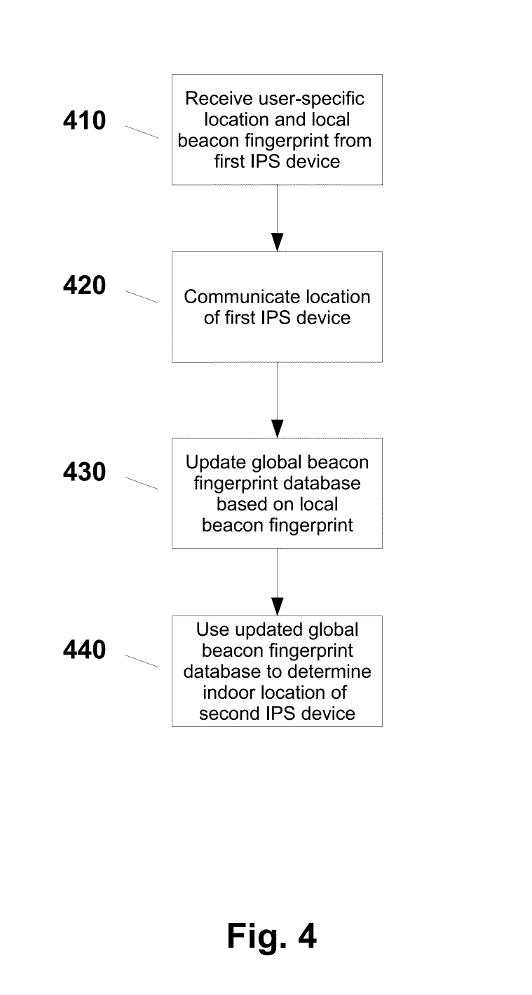

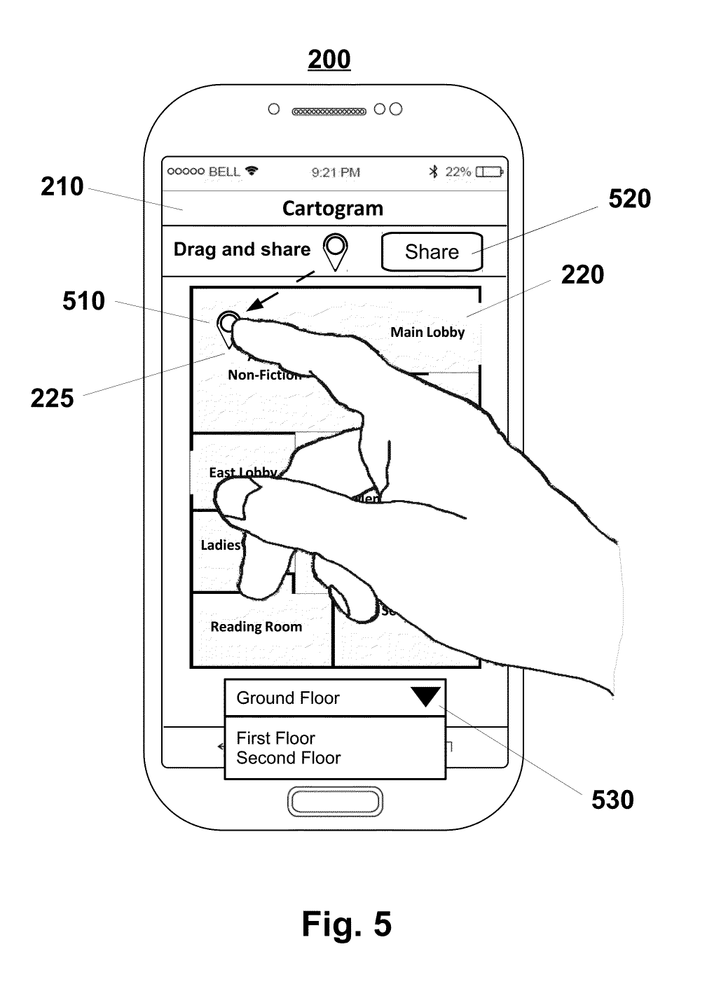

FIG. 4 is a flowchart illustrating an exemplary method of updating global beacon fingerprint information based on user-specific indoor location information and local beacon fingerprint information, as further depicted in FIGS. 5-9. The process may begin in step 410, when an IPS receives user-specific location information and a local beacon fingerprint from a first IPS-enabled device. As depicted in FIG. 5, in certain embodiments, the IPS-enabled device may be a handheld or mobile device, such as a smartphone 200. Device 200 may be IPS-enabled by virtue of hardware, firmware, software, or a combination of the foregoing. For example, device 200 may be equipped with hardware capable of detecting multiple beacon signals, such as Bluetooth signals, and measuring the strength of each such signal. Device 200 may make such signal reception and strength information available to software applications that execute on device 200, such as app 210.

App 210 may include one or more features for enabling a user to communicate his location. For example, app 210 may include a feature that allows the user to select the floor or level on which he is located using a control 530, at which point an indoor map 220 associated with the level is displayed. App 210 may then allow the user to drag a graphical pin 510 onto a specific location 225 on the displayed indoor map 220 and to share that location by activating a button 520. In some embodiments, upon the user's manual selection of his indoor location 225, app 210 may capture a local beacon fingerprint from device 200. A local beacon fingerprint may refer to a collection of information relating to the beacons detected by device 200 and their respective measured signal strengths at the time that the user captured his indoor location.

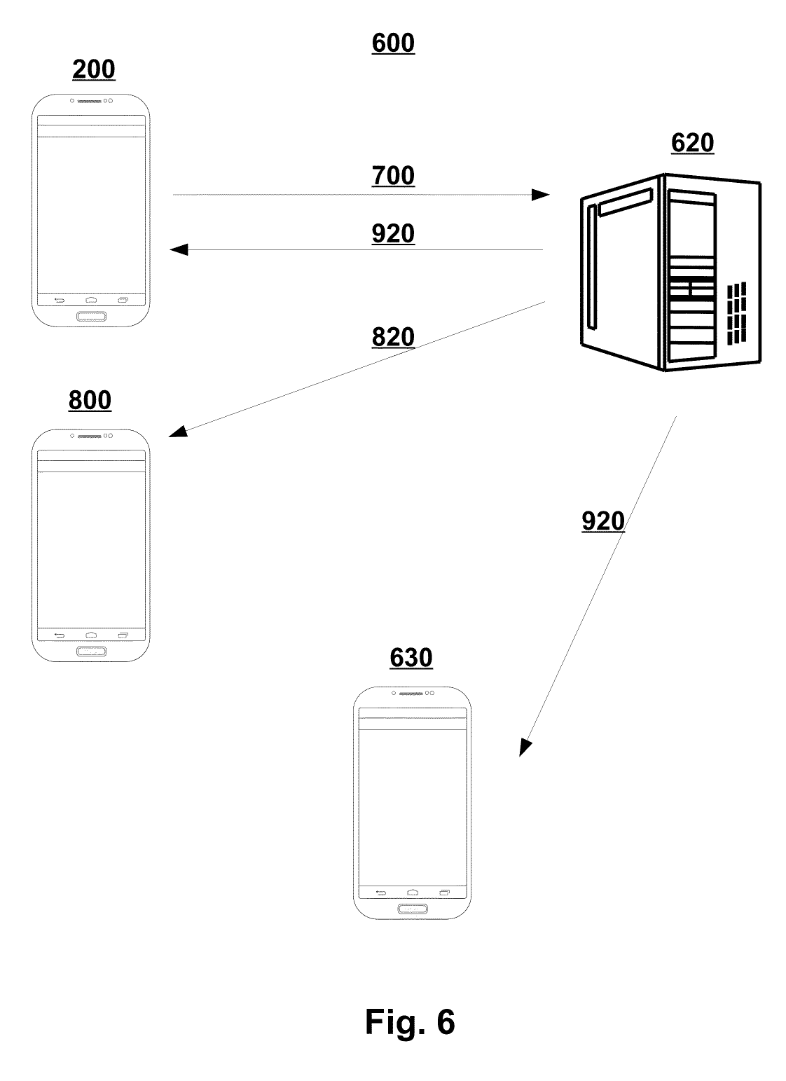

As depicted in FIG. 6, device 200 may send a communication 700 to an IPS backend 620 that includes the user-specified location 225 and the detected local beacon fingerprint. IPS backend 620 may be any device or collection of devices capable of maintaining one or more indoor maps, beacon information, device information, or any combination of the foregoing, and communicating with one or IPS-enabled devices. In some embodiments, IPS backend 620 may be a cloud backend comprising one or more dynamically allocated servers or virtual machines containing or having access to one or more data stores, such as relational or “NoSQL” databases.

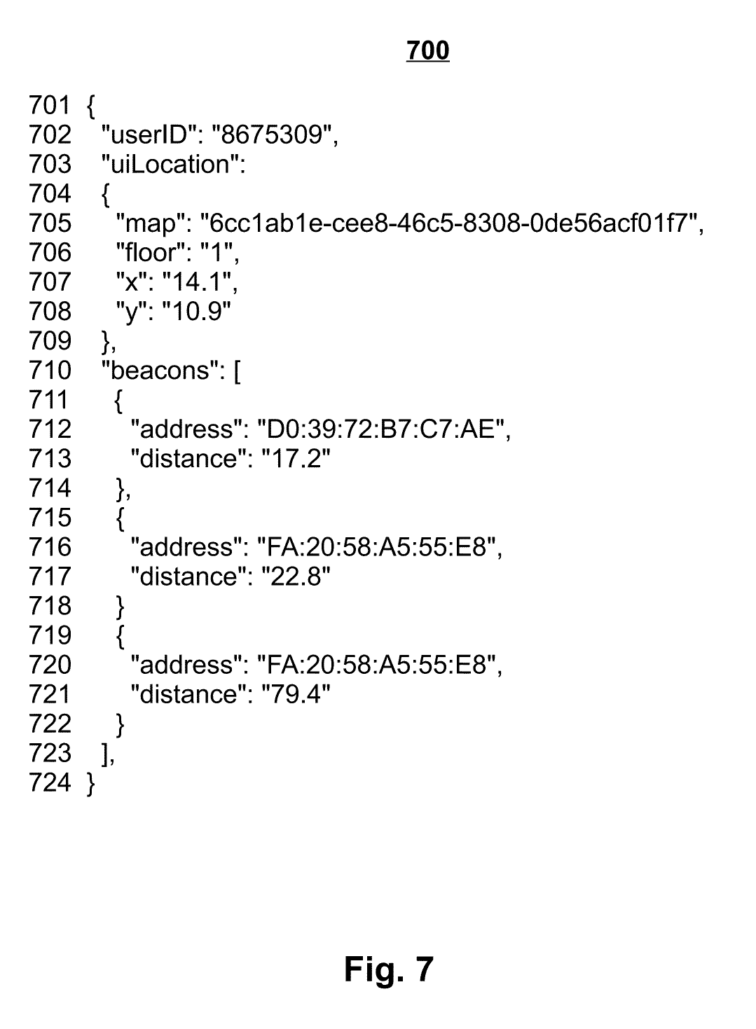

FIG. 7 is a diagram depicting exemplary user-specific indoor location information and local beacon fingerprint information. As depicted in FIG. 7, communication 700 may uniquely identify device 200 or a user profile within app 210 (line 702). Lines 703-709 depict an exemplary representation of the user-specified indoor location 225, wherein line 705 uniquely identifies the indoor map 220 in which the user has specified his location, line 706 indicates the relevant floor in the indoor map, and lines 707 and 708 indicate the user-specified location 225 in the form of X and Y coordinates relative to the top left corner of indoor map 220.

Lines 710-723 depict an exemplary representation of the local beacon fingerprint information captured at the time that the user shared his indoor location. Line 712 indicates the MAC address of a beacon whose signal was detected by device 200 (in this case beacon 110a), and line 713 indicates the presumed distance of the beacon. In this example, the app 210 has computed the presumed distance of the beacon from device 200 by comparing the RSSI of the beacon to its advertised broadcast strength, and app 210 has communicated only such computed distance to IPS backend 620. In other embodiments, app 210 may alternatively or additionally communicate the RSSI and advertised broadcast strength to IPS backend 620 in order to allow IPS backend 620 to perform its own distance calculations based on such information. Lines 716 and 717 represent the information detected from beacon 110b, and lines 720 and 721 represent the information detected from beacon 110c. Although not depicted, device 200 may have detected and measured beacons 110d-110j and included such information as part of the local beacon fingerprint information communicated to IPS backend 620.

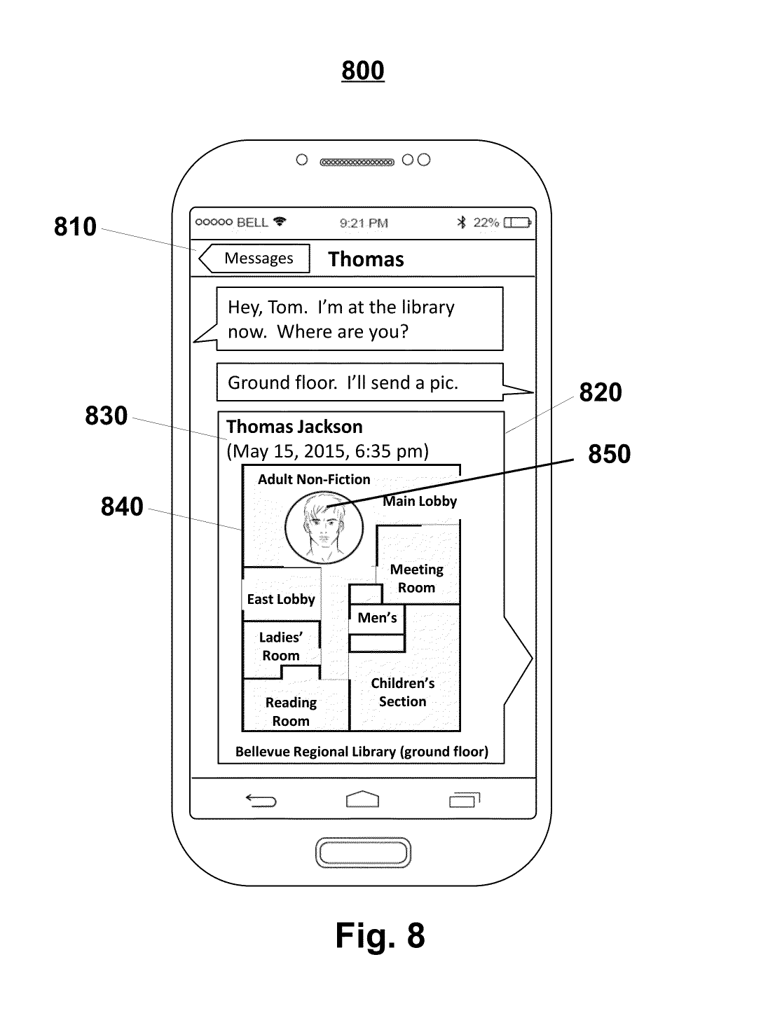

Returning to FIG. 4, in step 420, the IPS may communicate the location of device 200 to one or more other devices. For example, as depicted in FIGS. 6 and 8, IPS backend 620 may send a communication 820 to a second mobile device 800 in the form of an MMS message or other non-IPS-specific message format. One advantage to sending communication 820 in the form of a non-IPS-specific message format is that device 800 may receive indoor location information from an IPS-enabled device without being IPS-enabled itself. In some embodiments, device 800 may be non-IPS-enabled by virtue of not having hardware or operating system software capable of enabling IPS location determinations. In other embodiments, device 800 may be non-IPS-enabled simply by virtue of not having IPS software, or the same IPS software used by device 200, installed.

Thus, as depicted in FIG. 8, if communication 820 is formatted as an MMS message, device 800 may use a standard MMS messaging application 810 to receive and display the location information. For example, communication 820 may be formatted as an MMS message that displays sender information 830 that includes the identity of the user who transmitted his location, as well as the time at which his location information was captured or transmitted. Communication 820 may further include a textual or visual indication of the transmitting user's location, such as a map 840 corresponding to the map in which the transmitting user identified his location and a picture 850 of the transmitting user that is placed within map 840 according to the transmitting user's identified location. In some embodiments, device 200 may send message 820 to device 800 without going through an IPS backend 620, such as through a standard text message service.

In some embodiments, device 800 may receive and/or display map 840 and picture 850 through email or through a social network. In some embodiments, a user may manually indicate the location of another user in IPS app 210 and the other user's IPS device may respond by automatically transmitting local beacon fingerprint information to IPS backend 620 without the involvement of the user of such device. In other embodiments, certain devices that remain stationary in a building may automatically capture local beacon fingerprint information at a given interval or frequency and transmit the same to IPS backend 620. Because such devices are stationary, their location information may be known with each transmission. In still other embodiments, the foregoing techniques may be used to communicate the indoor location of an object, rather than a person. For example, a store may offer a special on grill-ready beef patties on a summer holiday. The store may drag a pin to a location in an indoor map that indicates where the patties are available for purchase. The store may then transmit that location to one or more IPS-enabled devices that are detected to be in the store and/or to one or more non-IPS-enabled devices through text message, webpage URL, or social media alert or message.

In the foregoing embodiment, the user of device 800 may see where the transmitting user is within the indoor map without using IPS-enabled hardware or software. Such functionality alone is very useful for enabling users to communicate indoor location information to each other without the need to rely on beacons or an up-to-date beacon fingerprint database. In some embodiments, however, such user-provided location information may be used by an IPS to automatically update and increase the accuracy of its global beacon fingerprint database (step 430).

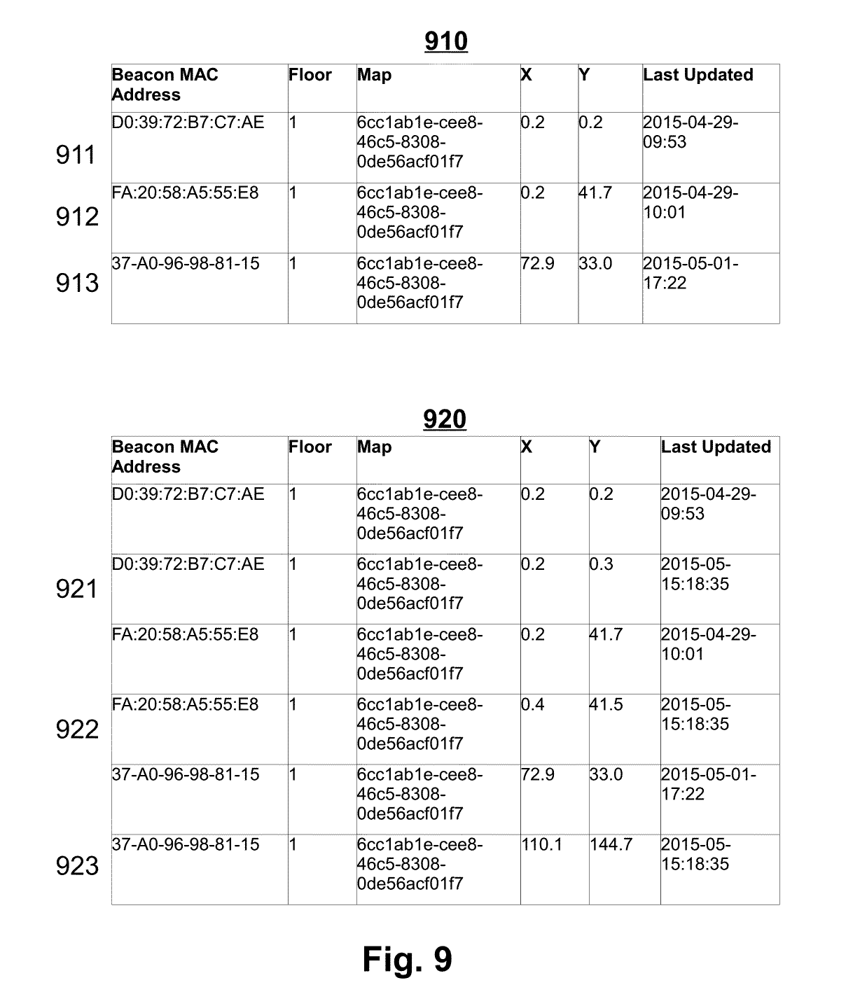

Thus, for example, as depicted in FIGS. 6 and 9, IPS backend 620 may include a beacon database 900 that is continually updated in response to receiving user-specific information. FIG. 9 depicts an exemplary transformation of beacon database 900 as a result of receiving user-specific location information from device 200 and communicating such information (or information derived from it) to device 800. Database snapshot 910 depicts a subset of database 900 as it might have existed prior to receiving communication 700.

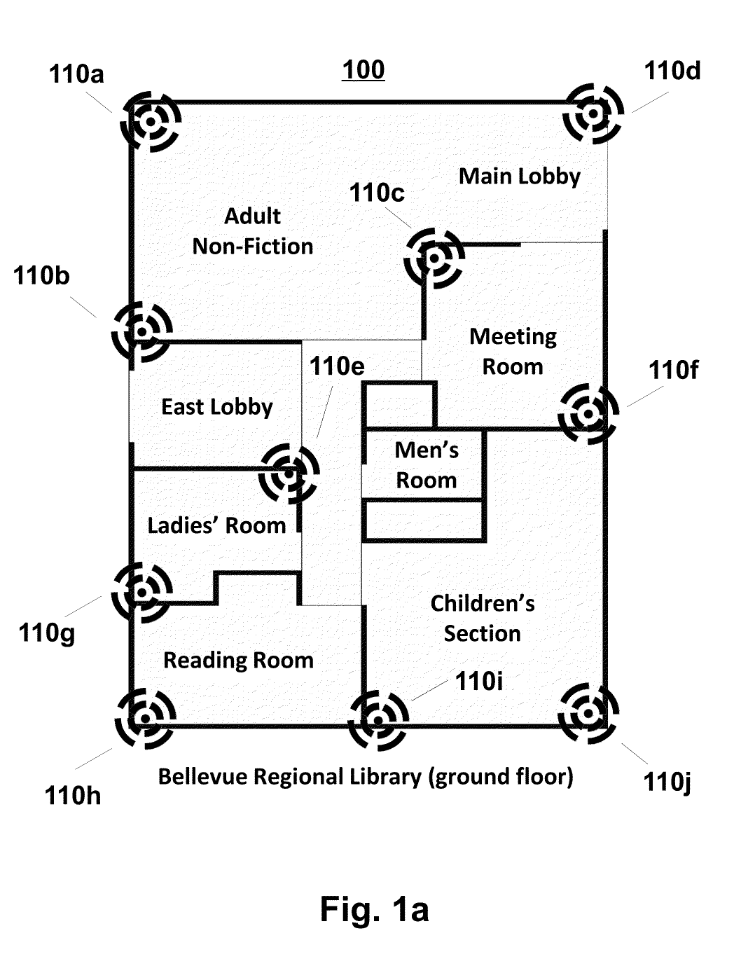

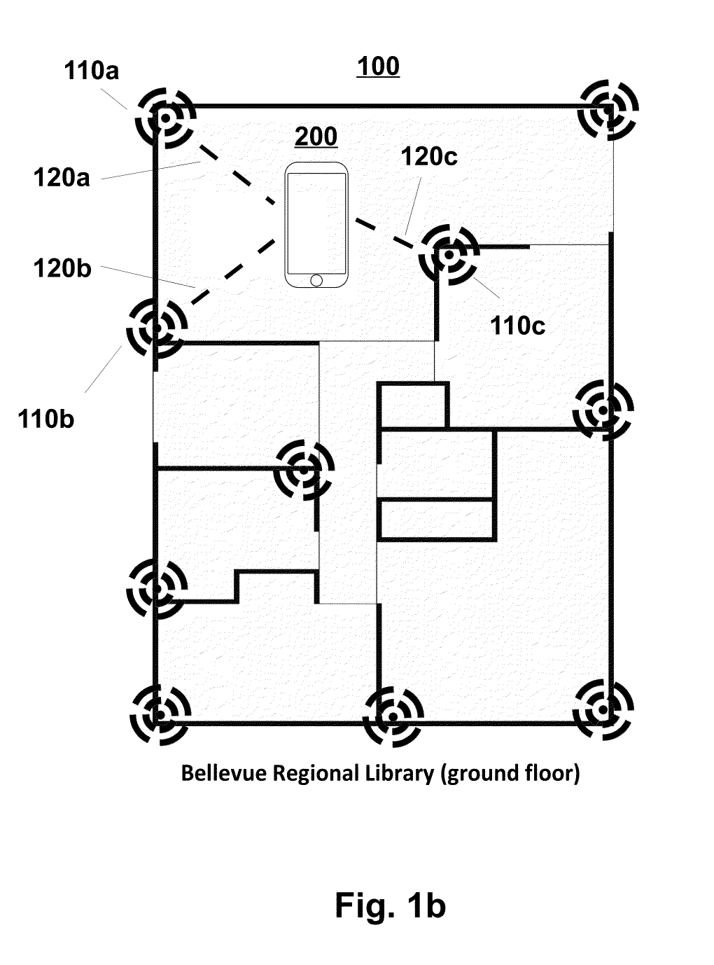

For example, database rows 911-913 may represent the latest information known to IPS backend 620 about beacons 110a-110c, respectively. For each beacon (as represented by its MAC address), database snapshot 910 may store the map and floor in which the beacon is located, the location of the beacon within the map (in the form of X and Y offsets from the top left corner), and the timestamp corresponding to when the information was entered into database 900. As can be seen, the beacon information reflected in database snapshot 910 corresponds to the placement of beacons 110a-110c depicted in FIG. 1a.

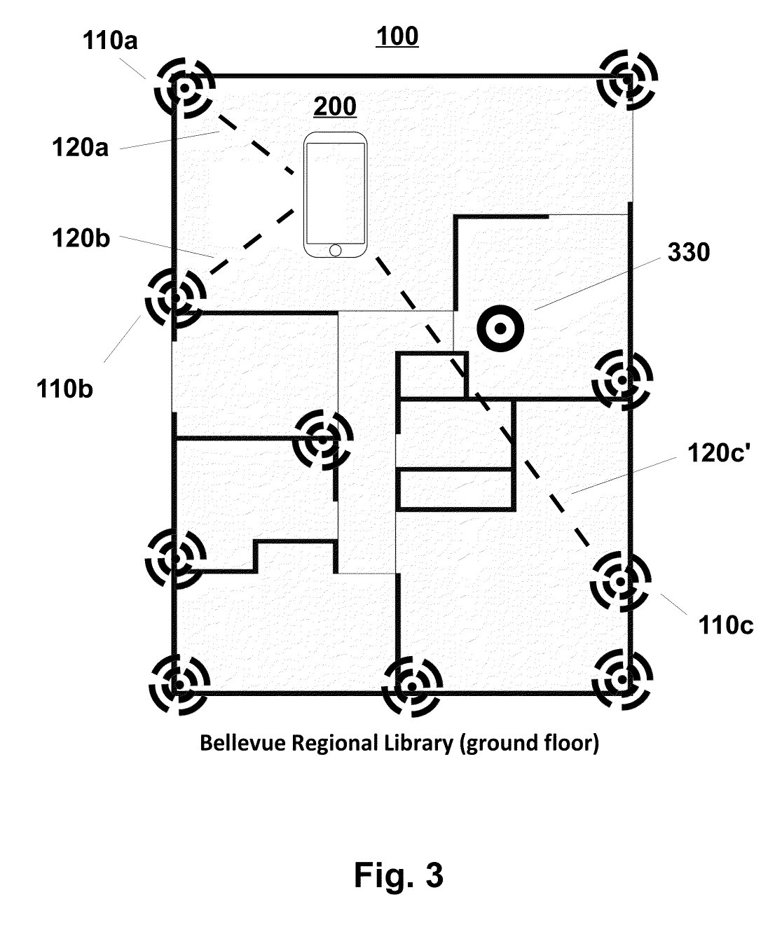

However, as depicted in FIG. 3, beacon 110c may have been moved to a different location on floor 100 after entry of the information in database snapshot 910. Thus, when IPS backend 620 receives user-specific indoor location information matching pin 510, the local beacon fingerprint information may not match the expected values according to database snapshot 910. For example, although the measured distances of device 200 from beacons 110a and 110b (lines 713 and 717 in FIG. 7) are consistent with the information in database snapshot 910 for a device in the location indicated by pin 510, the measured distance of device 200 from beacon 110c (line 721 in FIG. 7) is not. Accordingly, IPS backend 620 may update database 900 (reflecting global beacon fingerprint information) with the local beacon fingerprint information received from device 200.

In some embodiments, as depicted in FIG. 9, rather than overwriting beacon fingerprint information in database 900 to match the received local beacon fingerprint information, IPS backend 620 may simply augment database 900 with new rows 921, 922, and 923 that reflect such local beacon fingerprint information. Thus, as depicted in database snapshot 920, while rows 921 and 922 (representing beacons 110a and 110b, respectively) have values that are close to those of rows 911 and 912, respectively, the X and Y values in rows 923 and 913 differ significantly.

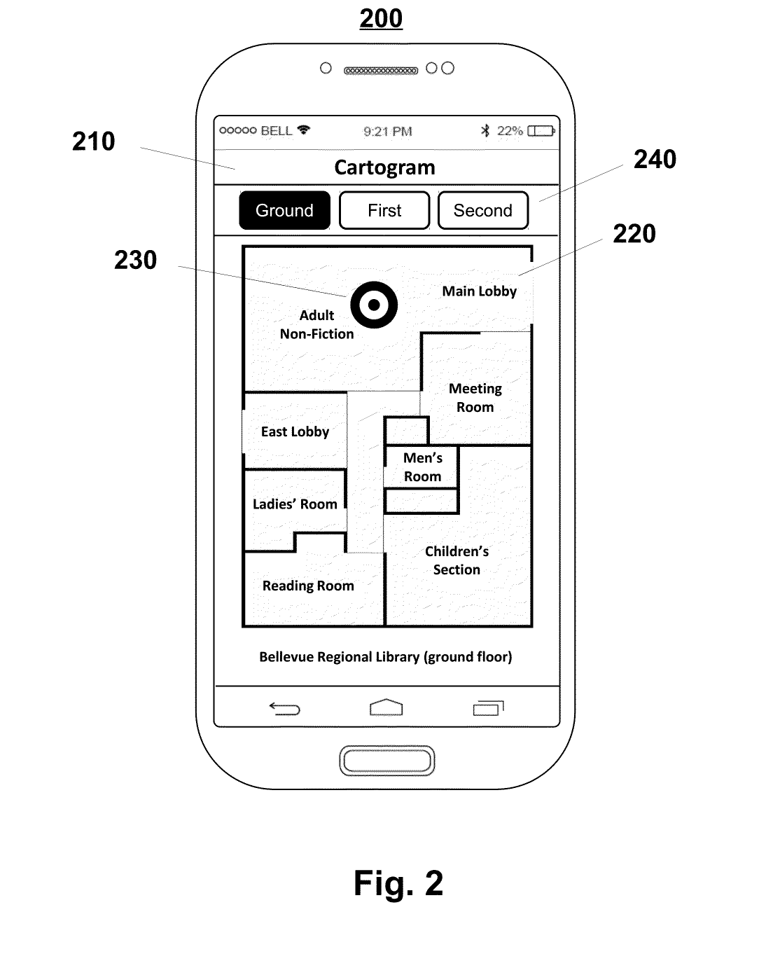

Returning to FIG. 4, in step 440, the IPS may use the updated global beacon fingerprint database to determine the indoor location of a second IPS device. For example, as depicted in FIG. 6, IPS backend 620 may transmit the updated global beacon fingerprint information contained in database snapshot 920 to one or more IPS-enabled devices, such as IPS-enabled devices 200 and 630. After receiving such updated global beacon fingerprint information, IPS-enabled devices 200 and 630 may use the updated information to better determine their indoor locations. For example, as depicted in FIGS. 2 and 3, after having received updated global beacon fingerprint information, rather than calculating an incorrect indoor location 330 based on outdated information about the location of beacon 110c, device 200 may properly determine its location 230.

Such updated global beacon fingerprint information may be used to determine indoor location using a variety of techniques. For example, if an IPS-enabled device includes or has access to updated global beacon fingerprint information 920, the device may use multiple entries for each detected beacon but may assign a greater weight to the more recent entries. The foregoing technique may be useful for smoothing out significant additions to the global beacon fingerprint database that may or may not be accurate. For example, a faint signal from a beacon that previously would have been strong for an IPS-enabled device in a particular location could be caused by the beacon having been moved, or it could have been caused by other factors, such as a low battery in the beacon or temporary placement of a dielectric object between the IPS-enabled device and the beacon. By retaining old beacon fingerprint information after new local beacon fingerprint information is added to the global beacon fingerprint database, the system may smooth out errant data.

In some embodiments, in addition to sending user-specific location information and local beacon fingerprint information to IPS backend 620, IPS app 210 may also collect sensor data from device 200 that is not directly related to detection of beacons. For example, device 200 may include additional sensors, such as a gyroscope that measures the orientation of device 200 and an accelerometer that measures the inertial state of device 200. IPS app 210 or IPS backend 620 may use such additional non-IPS-related sensor data to further interpret or weight the local beacon fingerprint information. For example, if the gyroscope sensor data indicates that the top of device 200 is facing toward a particular beacon while facing away from another beacon, such information might be used to normalize the detected RSSI values such that a portion of the lower RSSI value of the second beacon is attributed to the orientation of the device rather than distance from the second beacon. As another example, if the accelerometer indicates that device 200 is moving or accelerating in a particular direction, the local beacon fingerprint information may be modified to account for potential redshift or blueshift.

Those skilled in the art will appreciate that the nature of the local beacon fingerprint information, the storage of global beacon fingerprint information, or the method for updating global beacon fingerprint information with local beacon fingerprint information may differ and that other techniques may be used.

The foregoing description relates to the entry of a single local beacon fingerprint to the global beacon fingerprint database. In some embodiments, multiple individual IPS-enabled devices may contribute their local beacon fingerprint information to the global beacon fingerprint database using a variety of techniques. For example, IPS app 210 may include alternative functionality that allows a user to indicate his or her indoor location by simply tapping on a room in indoor map 220 or by selecting the room from a list of indoor locations.

In some embodiments, the IPS system may also be configured to infer a user's location from other actions that are not primarily intended to communicate position. For example, a user may send a textual message to another user. An IPS system that monitors textual messages may infer the user's location based on the content of the message. After so inferring, the IPS system may instruct the user's device to collect local beacon fingerprint information and send the same back to the IPS system in order to update the global beacon fingerprint database.

To reduce the likelihood of false location inferences based on text, in some embodiments, the IPS system may collect local beacon fingerprint information only if the IPS system determines that the text exceeds a certain probability of indicating user location. For example, the IPS system may determine that the message “Hey, I'm upstairs in the lounge, come meet me here” has a sufficiently high probability of indicating that the user is in the lounge area, whereas the message “I'm almost done with the dryer, anyone need it?” does not have a sufficiently high probability of indicating the user is in the laundry room. In other embodiments, the IPS system may infer user location from, and collect local beacon fingerprint information as a result of, both messages, but the IPS system may assign different weights to the collected local beacon fingerprints based on the confidence score associated with each. In the case of the statement, “I'm almost done with the dryer, anyone need it?,” the IPS system may employ a process for mapping the word “dryer” to a physical location in the building. For example, the IPS system may include a database of objects or object names that are associated with locations in the building. If a given object is associated with more than one location, the IPS system may use the collected local beacon fingerprint information to infer the correct location.

The foregoing techniques may also be used to determine the location of other persons who are not interacting with the device from which messages are being sent. For example, if a user mentions another person in connection with a location—e.g., “Jane and I are in the lobby. You coming?—the IPS system may infer the location of the person (here, “Jane”) from the content of the message. The IPS system may then instruct Jane's device to capture and transmit local beacon fingerprint information.

In some embodiments, two or more devices may work together to collect local beacon fingerprint information. For example, a first user may use her mobile device to take a picture of a second user. The first user's mobile device may or may not be able to detect beacons and estimate location based on the same. However, the first user's mobile device (or an IPS backend) may perform facial recognition on the second user in the captured image to determine the identity of the second user. Upon determining the identity of the second user, the first user's mobile device (or the IPS backend) may instruct the second user's IPS-enabled mobile device to capture local beacon fingerprint information and transmit the same back to the IPS backend for the purpose of updating the global beacon fingerprint database. If there are additional objects in the room, the second user's location may also be inferred and used to provide context to the collected and transmitted local beacon fingerprint information. For example, if the picture includes a pool table, the system may infer that the second user is in the billiards room.

In other embodiments, a first device may detect the presence of a second, IPS-enabled device. The first device may determine that the second device is within a certain proximity of the first device upon the occurrence of a certain action that suggests that the user of the second device is interacting with the first device. For example, a coffee machine could be equipped with a sensor. The coffee machine might detect the presence of an IPS-enabled mobile device through Bluetooth or other detection mechanisms known to those skilled in the art. The coffee machine might take no action until the user interacts with the coffee machine in some way, such as initiating a brewing operation. Upon the occurrence of the user interaction, the coffee machine may infer that the user is within a certain distance (e.g., five feet) of the coffee machine. The coffee machine (or an IPS backend) may then instruct the user's IPS-enabled device to capture local beacon fingerprint information and transmit the same back to the IPS backend for the purpose of updating the global beacon fingerprint database.

If multiple IPS-enabled devices participate in the above techniques (or similar techniques) for capturing local beacon fingerprint information and transmitting the same to an IPS backend, the global beacon fingerprint database maintained by the IPS backend may continually be updated and improved with crowdsourced information. Thus, if actual changes occur to the locations, identities, or operation of beacons within an indoor environment, the IPS backend may nonetheless flexibly maintain accurate information about the beacon configuration of the indoor environment without the need for (or as a temporary self-fixing measure until) manual updates to be made to the global beacon fingerprint database.

In some embodiments, the IPS system may wait until a certain threshold is reached with respect to the number of IPS-enabled devices supplying local beacon fingerprint information, or the amount or frequency of local beacon fingerprint information being collected, before including such crowd-sourced beacon fingerprint information in its indoor location calculations. The threshold may go up or down based on the number of fingerprints in the system, per floor or per building (or a combination), or based on how recent the fingerprints are or their distribution. The IPS system may also include a mechanism for incentivizing users to manually share their indoor location information or to turn on automatic location sharing. For example, the IPS system may provide rewards in proportion to the degree to which users assist in calibrating the global beacon fingerprint database.

Such crowdsourced updates to the global beacon fingerprint database may be used by all participating IPS-enabled devices to estimate their indoor locations. In some embodiments, the updated global beacon fingerprint information may be transmitted to participating IPS-enabled devices, which may estimate their own indoor locations using the received information. In other embodiments, a participating IPS-enabled device may send its detected local beacon fingerprint information to the IPS backend, and the IPS backend may estimate the IPS-enabled device's indoor location based on the global beacon fingerprint database and transmit the estimated indoor location back to the IPS-enabled device. In some cases, this latter embodiment may be preferred, since if many IPS-enabled devices participate in crowdsourcing updates to the global beacon fingerprint database, the global beacon fingerprint database may be frequently updated, which may make it impractical or transmission-expensive to continually send updated global beacon fingerprint information to multiple participating IPS-enabled devices.

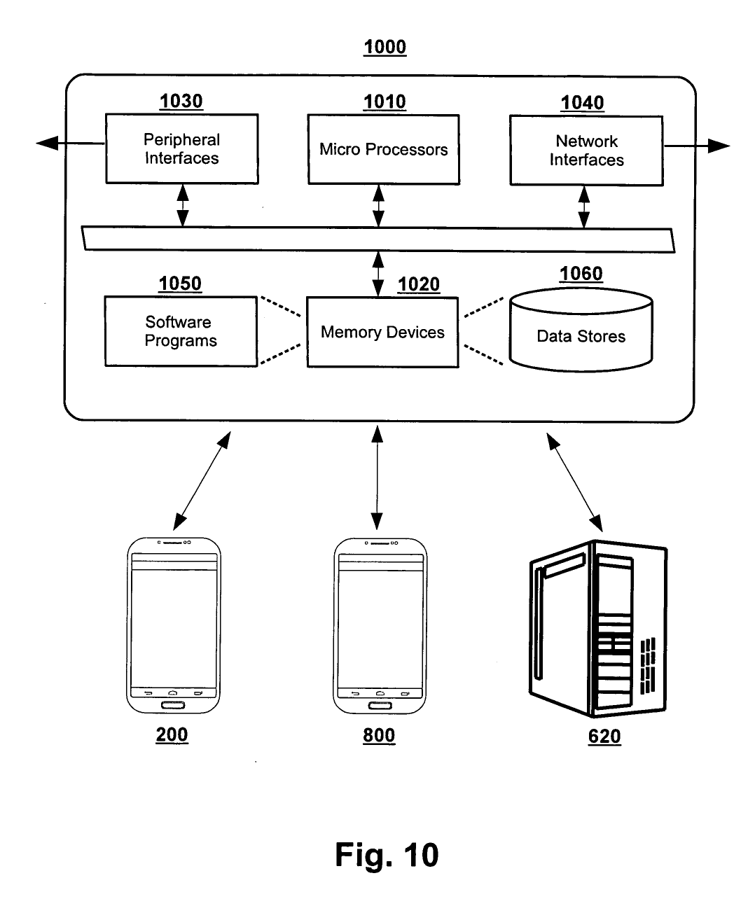

FIG. 10 is a diagram depicting an exemplary hardware configuration 1000 for any device in an IPS system capable of practicing the above embodiments, such as an IPS-enabled mobile device 200, a non-IPS enabled mobile device 800, and one or more IPS backend servers 620. Hardware configuration 1000 may include one or more microprocessors 1010 of varying core configurations and clock frequencies; one or more memory devices or computer-readable media 1020 of varying physical dimensions and storage capacities, such as flash drives, hard drive, random access memory, etc. for storing data, such as files, images, and/or program instructions for execution by one or more microprocessors 1010; one or more network interfaces 1040, such as Ethernet adapters, wireless transceivers, or serial network components, for communicating over wired or wireless media using protocols, such as Ethernet, wireless Ethernet™, Bluetooth™, GSM, WiMAX™, etc.; and one or more peripheral interfaces 1030, such as keyboards, mice, touchpads, computer screens, touchscreens, etc., for enabling human interaction with and manipulation of computing system 1000. In some embodiments, the components of computing system 1000 need not be enclosed within a single enclosure or even located in close proximity to one another.

Memory devices 1020 may further be physically or logically arranged or configured to provide for or store one or more data stores 1060, such as one or more file systems or databases, and one or more software programs 1050, which may contain interpretable or executable instructions for performing one or more of the disclosed embodiments. Those skilled in the art will appreciate that the above-described componentry is exemplary only, as computing system 1000 may comprise any type of hardware componentry, including any necessary accompanying firmware or software, for performing the disclosed embodiments. Computing system 1000 may also be implemented in part or in whole by electronic circuit components or processors, such as application-specific integrated circuits (ASICs) or field-programmable gate arrays (FPGAs).

The foregoing description of the present disclosure, along with its associated embodiments, has been presented for purposes of illustration only. It is not exhaustive and does not limit the present disclosure to the precise form disclosed. Those skilled in the art will appreciate from the foregoing description that modifications and variations are possible in light of the above teachings or may be acquired from practicing the disclosed embodiments.

For example, although embodiments have been described in terms of interaction with a user, the above-described techniques are equally applicable to implementations that do not involve human users. Thus, the same techniques may be used to execute programs according to instructions received from another program in computing system 1000 or from another computing system altogether. Similarly, commands may be received, executed, and their output returned entirely within the processing and/or memory of computing system 1000.

Likewise, the steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims in light of their full scope of equivalents.

In the below claims, unless specified otherwise, the term “IPS-enabled” and its variants are to be interpreted to mean that a device is capable of detecting signal emissions from nearby beacons, measuring the respective strengths of such signals, and estimating its indoor location based on the same. A device may have the hardware capabilities to perform the foregoing actions but may not be IPS-enabled at a point in time if it does not have software installed at that time for performing the foregoing actions (or if it does not have IPS software installed that is compatible with the IPS software used by another device that is attempting to communicate indoor location information to it).

What is claimed is:

1. A computer-implemented method of communicating indoor location information, the method comprising:
receiving, using a first electronic device, an indication of a user-selected indoor location; and
transmitting, using the first electronic device, a representation of the user-selected indoor location to a second electronic device.

2. The method of claim 1, wherein the first electronic device is IPS-enabled and the second electronic device is not IPS-enabled.

3. The method of claim 2, wherein the indication of the user-selected indoor location is provided by the user positioning a graphical marker within an electronic display of an indoor map using the first electronic device.

4. The method of claim 2, wherein, the indication of the user-selected location is provided by the user selecting an area that is a subset of a displayed indoor map using the first electronic device.

5. The method of claim 2, wherein the indication of the user-selected location is provided by the user selecting a location from a list of locations within an indoor map using the first electronic device.

6. The method of claim 2, wherein the representation is an MMS message that includes a digital image of an indoor map in which the user-selected location is located.

7. The method of claim 6, wherein the representation further includes a graphical marker that is displayed on top of the indoor map representing the position of the user-selected location within the indoor map.

8. The method of claim 2, wherein the representation is a URL to a webpage that displays the user-selected location within the indoor map.

9. A computer-implemented method of updating beacon information, the method comprising:
receiving, from a first IPS-enabled electronic device, location information and beacon detection information, wherein the location information is indicative of a location of the first IPS-enabled electronic device and the beacon detection information indicates identities and detected signal strengths of one or more beacons detected by the first IPS-enabled electronic device; and
adding the beacon detection information to a beacon database to derive an updated beacon database, wherein the beacon database includes information about identities and locations of a plurality of beacons associated with an indoor map.

10. The method of claim 9, wherein the location information expressly indicates a user-provided location of the first IPS-enabled electronic device within the indoor map.

11. The method of claim 9, further comprising:
inferring a user-indicated location of the first IPS-enabled electronic device within the indoor map based on the content of the location information.

12. The method of claim 11, wherein the location information comprises a textual message transmitted by the user.

13. The method of claim 11, wherein the location information comprises an image.

14. The method of claim 13, wherein the image is a photograph captured by the first IPS-enabled electronic device.

15. The method of claim 13, wherein the image further includes a second photograph simultaneously captured by the first IPS-enabled electronic device from an opposite-facing camera.

16. The method of claim 9, wherein adding the beacon detection information to the beacon database further comprises updating estimated locations of one or more beacons associated with the indoor map within the beacon database.

17. The method of claim 9, further comprising estimating an indoor location of a second IPS-enabled electronic device using the updated beacon database.

18. The method of claim 17, further comprising sending information in the updated beacon database to the second IPS-enabled electronic device to enable the second IPS-enabled electronic device to estimate its indoor location based on a comparison of beacon identities and signal strengths detected by the second IPS-enabled electronic device and the information in the updated beacon database.

19. The method of claim 17, further comprising:
receiving second beacon detection information from the second IPS-enabled electronic device;
estimating the indoor location of the second IPS-enabled electronic device using the updated beacon database; and
sending the estimated indoor location to the second IPS-enabled electronic device.

20. The method of claim 9, further comprising:
receiving, from the first IPS-enabled electronic device, non-IPS sensor data; and
adjusting calculated distances between the first IPS-enabled electronic device and the plurality of beacons based on the non-IPS sensor data.

21. A computer-implemented method of updating beacon information, the method comprising:
receiving from a first electronic device an indication that a second electronic device is in close proximity to the first electronic device, wherein the second electronic device is IPS-enabled;
receiving from the second electronic device beacon detection information, where the beacon detection information indicates identities and detected signal strengths of one or more beacons detected by the second IPS-enabled electronic device; and
adding the beacon detection information to a beacon database to derive an updated beacon database, wherein the beacon database includes information about the identities and locations of a plurality of beacons associated with an indoor map.

22. The method of claim 21, further comprising:
sending a request to the second electronic device to send the beacon detection information; and
receiving the beacon detection information in response to the request.

23. The method of claim 21, wherein the beacon detection information is sent by the second electronic device in response to an instruction sent from the first electronic device to the second electronic device.
